(19) United States
(12) Patent Application Publication
(10) Pub. No.: US 2016/0321765 A1
(43) Pub. Date: Nov. 3, 2016

(54) FACILITATING COMPLETION OF ACTIVITIES BY A USER

(71) Applicant: ADVENTURE JUNKY ENTERPRISES PTY LTD, New South Wales (AU)

(72) Inventors: Nigel Keith Malone, New South Wales (AU); Fuchsia Claire Sims, New South Wales (AU)

(21) Appl. No.: 15/104,881

(22) PCT Filed: Dec. 11, 2014
(86) PCT No.: PCT/AU2014/050418

§ 371 Date: Jun. 15, 2016

(30) Foreign Application Priority Data
Dec. 16, 2013 (AU) 2013904898

(51) Int. Cl. G06Q 50/14; G06Q 30/02

(52) U.S. Cl. CPC G06Q 50/14; G06Q 30/0231

(57) ABSTRACT

A computer-implemented method performed by a mobile communication device for facilitating the completion of activities by a user, where the mobile communication device is in communication with a server that is in turn in communication with a datastore, the datastore stores information identifying a plurality of activities, a reward associated with completion of each of the activities, and an account associated with the user, the method comprising: receiving information identifying an activity using near field communication; sending a request over a communications network to the server to store in the datastore associated with the user's account an indication of completion of the activity, wherein the request includes information identifying the activity; and receiving over the communications network from the server confirmation that the user's account in the datastore has been updated with a reward associated with completion of the activity.

### TECHNICAL FIELD

This disclosure generally concerns completing activities, and more particularly, a computer-implemented method performed by a mobile communication device for facilitating the completion of activities by a user, and a method for determining completion score of activities. In one example, the activities are travel adventures. This disclosure also concerns a computer system and a computer program employing one of these methods.

### BACKGROUND ART

Every year 1.5 billion travellers seek the physical, spiritual and emotional highs of adventure travel, yet their journey is full of dead-ends and detours.

### SUMMARY

There is provided a computer-implemented method performed by a mobile communication device for facilitating the completion of activities by a user, where the mobile communication device is in communication with a server that is in turn in communication with a datastore, the datastore stores information identifying a plurality of activities, a reward associated with completion of each of the activities, and an account associated with the user, the method comprising:

(a) receiving information identifying an activity using near field communication;

(b) sending a request over a communications network to the server to store in the datastore associated with the user's account an indication of completion of the activity, wherein the request includes information identifying the activity; and

(c) receiving over the communications network from the server confirmation that the user's account in the datastore has been updated with a reward associated with completion of the activity.

It is an advantage that completion of an activity can be independently and seamlessly validated using the convenience of a mobile communication device. Typically the near field communication is located in a way that access to the location to use the near field communication is how a user confirms completion of the activity. It is a further advantage that the user's account is updated with the reward associated with the completion of candidate activity.

The request may additionally include information received by the mobile communication device using global positioning system or a quick response code.

It is an advantage that seamless validation of the completion of the activity so that the reward can be associated with the user's account can be made more robust by replying on other means.

There is provided a computer program comprising computer-executable instructions to cause a computer to perform the method as stated above.

There is provided a mobile communication device for facilitating the completion of activities by a user, the mobile communication device comprising:

a communications port for communication with a server that is in turn in communication with a datastore, the datastore stores information identifying a plurality of activities, a reward associated with completion of each of the activities, and an account associated with the user, and for receiving information identifying an activity using near field communication; and

a processing device
to receive the information identifying the activity using near field communication;
to send a request over a communications network to the server to store in the datastore associated with the user's account an indication of completion of the activity, wherein the request includes the information identifying the activity; and to receive over the communications network from the server confirmation that the user's account in the datastore has been updated with a reward associated with completion of the activity.

There is provided a computer-implemented method performed by a server for determining completion score values of activities to be completed by a user, wherein information on at least one activity and at least one criteria are stored on a datastore, the method comprising:

(a) storing in the datastore a score value for each of the criteria associated with the activity;

(b) determining the completion score value for the activity based on the score value for each of the criteria associated with the activity; and

(c) storing the completion score value for each activity in the datastore.

It is an advantage that determining completion scores for the candidate activities are performed objectively considering all criteria.

The criteria stored in the datastore may be criteria applicable to each of the one or more activity.

The criteria may be any one or more of:

difficulty,

cost,

fitness requirement,

duration, and

distance from home location.

There is provide a computer program comprising computer-executable instructions to cause a computer to perform the method of determining completion scores of activities as stated above where appropriate.

There is provided a computer system for determining completion score values of activities to be completed by a user, comprising:

a datastore to store information on at least one activity and at least one criteria, and to store a score value of each of the criteria associated with the activity; and

a processing device to determine the completion score value for the activity based on the score value for each for the criteria associated with the activity, and to cause the completion score value for the activity to be stored in the datastore.

### BRIEF DESCRIPTION OF DRAWINGS

Examples will now be described with reference to the accompanying drawings, in which:

FIG. 1 illustrates a computer system for facilitating the completion of activities by a user over a communication network;

FIGS. 2(a) to 2(c) illustrate a method for facilitating the completion of activities by a user over a communication network;

FIG. 3 illustrates an example structure of a datastore;

FIG. 4 illustrates the server software system;

FIG. 5 illustrates the client software system;

FIGS. 6(a) and 6(b) illustrate the user interface of the user authentication system on the client software;

FIGS. 7(a) and 7(b) illustrate the user interface of the user profiling information on the client software;

FIGS. 8(a) and 8(b) illustrate the user interface of the user ranking information on the client software;

FIG. 9 illustrates the user interface of the travel searching system on the client software;

FIG. 10 illustrates the user interface of guided travel adventure on the client software;

FIG. 11 illustrates the user interface of self-guided travel adventure on the client software;

FIG. 12 illustrates the user interface of booking system on the client software;

FIG. 13 illustrates the user interface for making travel adventures enquiries on the client software;

FIG. 14 illustrates the user interface of the social media connect system on the client software;

FIG. 15 illustrates the user interface of Adventuregrams on the client software;

FIG. 16 illustrates the confirmation to the user on the client software in the event of earning points;

FIG. 17 illustrates the confirmation to the user on the client software in the event of earning patches;

FIG. 18 illustrates the confirmation to the user on the client software in the event of travel adventure activity completion;

FIG. 19 illustrates a method for determining the completion score values of activities to be completed by a user;

FIG. 20 illustrates criteria in realtion to activities;

FIG. 21 illustrates examples of travel adventures and the respective scores;

FIGS. 22(a) illustrates an example user mobile communication device according to the present disclosure; and

FIGS. 22(b) illustrates an example server according to the present disclosure.

### DETAILED DESCRIPTION

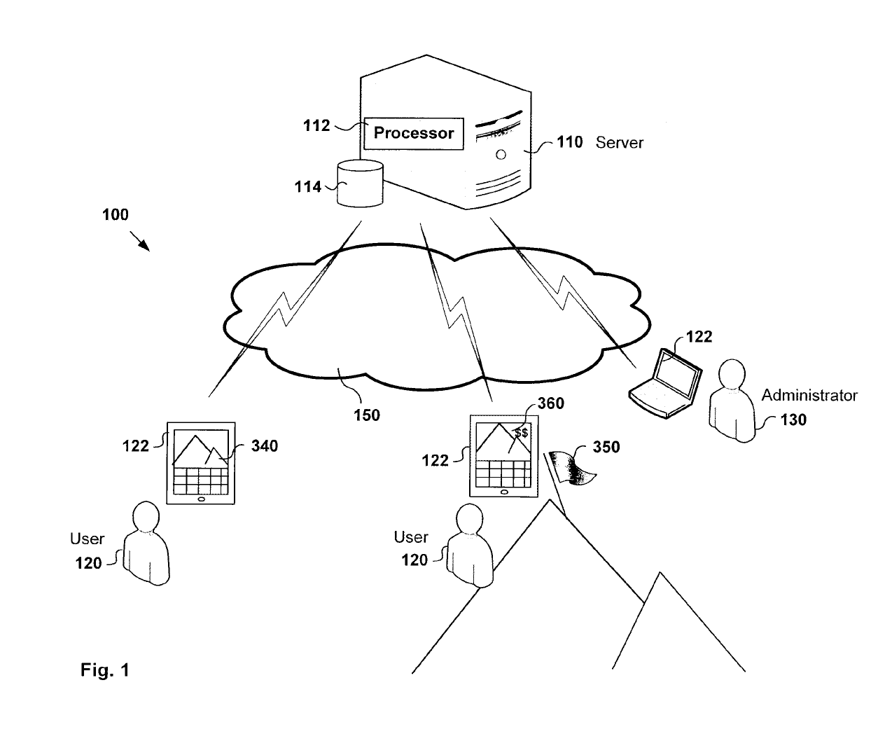

FIG. 1 shows an example computer system 100 for facilitating completion of activities of a user 120 and for determining completion score values of activities to be completed by the user 120.

The system 100 includes a server 110 in communication with users 120 and an administrator 130 over a communications network 150, including for example where appropriate the Internet and a mobile (wireless) communications network.

The users 120 and administrator 130 each operate a device 122 to communicate with the server 110. The device 122 may be any suitable Internet-capable electronic device, such as a mobile device (e.g. smartphone), personal digital assistant, tablet computer, desktop computer and laptop computer. A user 120 is typically an individual or group of individuals looking for complete activities, which in this example are typically experiences and other travel related activities. The administrator 130 is typically an entity responsible, either directly or indirectly, for the services provided by the server 110. Although not shown, the server 110 may communicate with third party systems to perform the various functionalities described here, and may include activity providers.

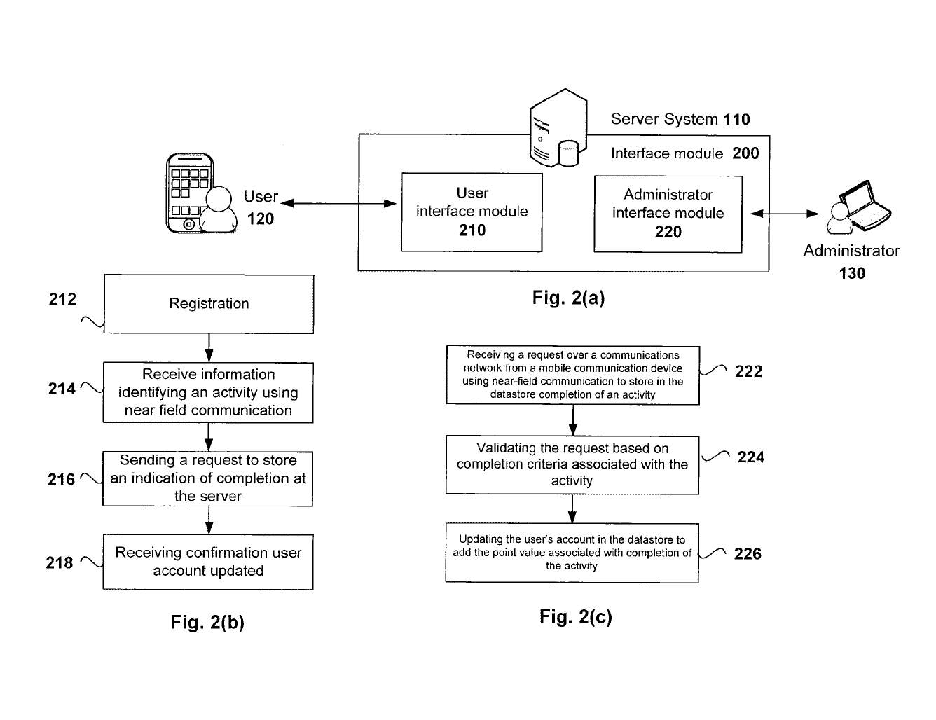

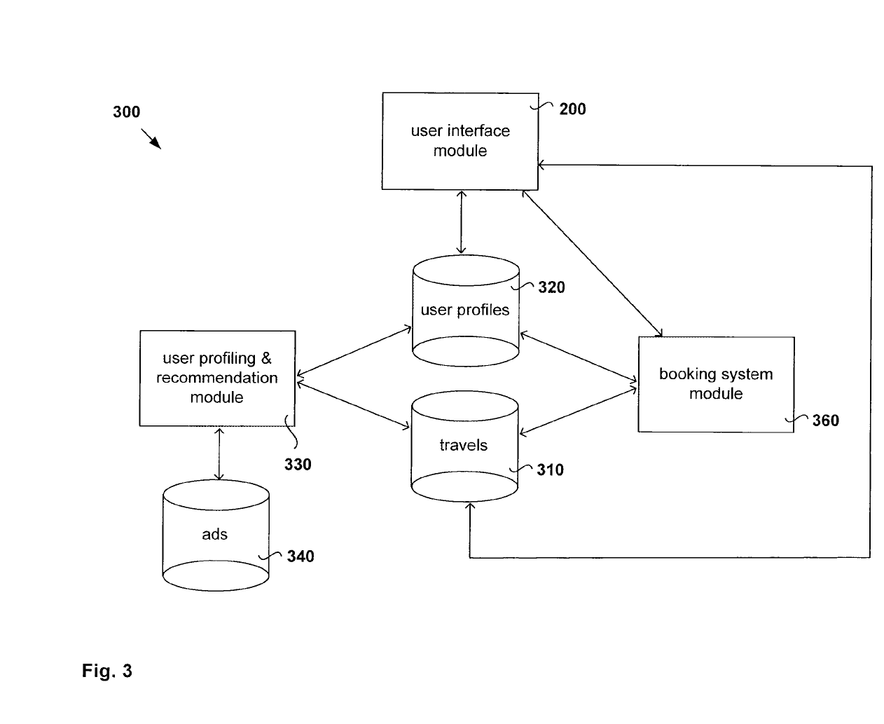

The server 110 includes at least one processor 112 and data store 114 (one shown for simplicity). Referring also to FIG. 2(a), the processor 112 implements an interface module 200 to handle communication from the users 120 and administrators 130 to utilise services provided by the server 110. All information needed by the server 110 on users 120, administrator 130, activities and advertisements is stored in the datastore 114. In one example, the datastore 114 is separated into three databases as shown in FIG. 3. The first database stores records on users 320. The second database stores records on activities 310 in this case travels. The third database stores records of advertisements 340. The three databases may be part of a database management system (DBMS) such that the records of the different databases are associated with each other, typically using repeated fields that uniquely identify records of a different database. Each of the three databases may each be comprised of multiple databases and may be stored in a distributed manner.

In FIG. 2(a), the example interface module 200 includes a user interface module 210 and an administrator interface module 220.

The user interface module 210 allows users 120 to connect with and utilise services provided by the server 110 in order for the users 120 to perform the functions shown in FIG. 2(b). The module 210 may also allow a user 120 to make a short list of activities to be completed, make a booking to complete an activity and otherwise explore the data related to the user and related to all activities.

The administrator interface module 220 allows administrators 130 to connect with and utilise services provided by the server 110. Particularly, the administrators 130 may provide, via the administrator interface module 220, a score value for each of the criteria associated with an activity. Additionally, the module 220 may allow an administrator 130 to explore the data related to users and activities, and update any information stored in the database 114.

In this example, the method flow shown in FIG. 2(b) is implemented at the user's mobile communication device 122, and the method flow shown in FIG. 2(c) is implemented at the server 110.

It will be appreciated that the method flow shown in FIG. 2(b) may be in any suitable form, such as web pages and software application (App) interfaces that may be displayed on a users' device 122. The method flow shown in FIG. 2(b) may include multiple user interfaces and may be optimised based on the device 122 used, such as its type, operating system and browser type and version.

Although not shown in FIG. 2(a), the interface module 200 may further include other modules to communicate with other users of the server 110, such as third party service providers associated with the external systems.

Server 110

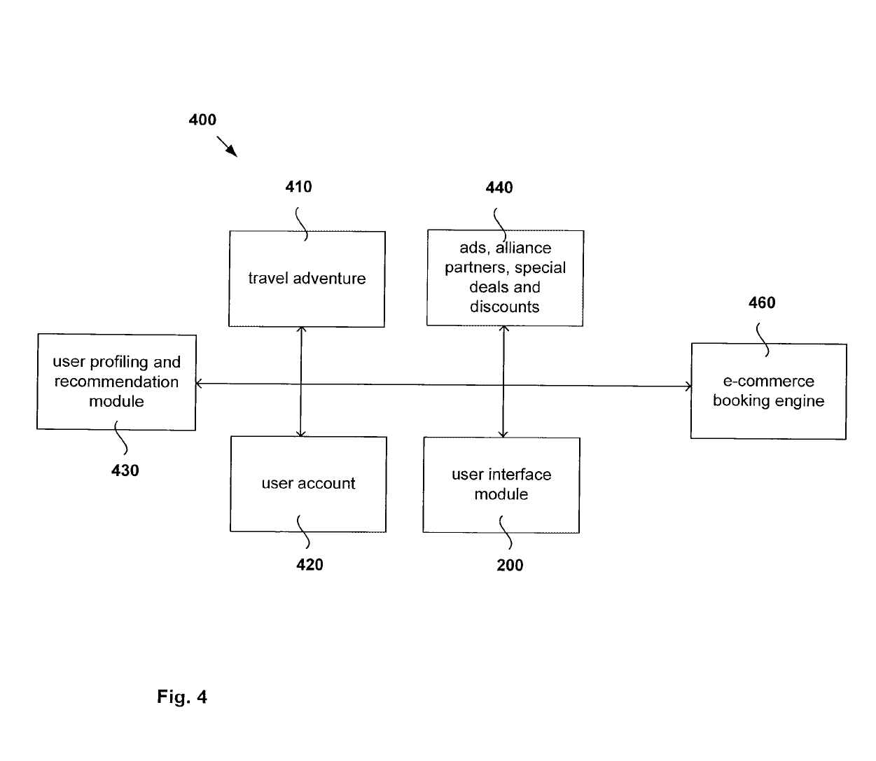

An example software system 400 as shown in on FIG. 4 is implemented on the server 110. The database 114 stores information relevant to activities, such as travel adventures 410, a database storing user accounts 420, a user profiling and recommendation module 430, a database storing advertisements, alliance partners, special deals and discounts 440, the user interface module 200, such as forum hosting, and an e-commerce booking engine 460.

The database 410 stores a variety of activity information and is not limited to images and movie clips of travel adventures around the world. For each travel adventure activity record stored in database 410 there is associated with the record additional information such as the respective reward (points score, merit patch etc), Global Positioning System (GPS) location, and any sub-activities that are included. Profiles and pictures of leading adventurers and their recommendations for any one or more activities are also stored in the database to exemplify the possibilities for users. For guided travel adventures, additional information such as the cost, duration and dates of availability are also included.

The user profiles database 420 on the server 110 stores user accounts that each include profile information of each user and such information includes basic personal information, a set of activities that the user wishes to complete (referred herein as bucket list), a set of criteria that the user prefers for their activities such as risk level (referred herein as comfort zone), a list of booked and completed activities, reward previously awarded including points and merit patches.

The user profiling and recommendation module 430 is used to determine the users' preferred range of adventure activities all having different from soft through to hard adventure, and recommend relevant adventures within or just outside their comfort zone. The module 430 is also used to determine a users' desired adventure destinations and experiences in order to connect them with such adventures, relevant gear/equipment/apparel, advice, offers, content and to other users.

An additional database 440 also resides on the server that stores information relating to advertisements. This include limited offers and discounted pricing on travel adventures, high-quality self-serve brand advertising limited to 30, 60 second video content, recommended gear, apparel or equipment and alliance partners, allowing users to gain discounts on flights and gear in-store.

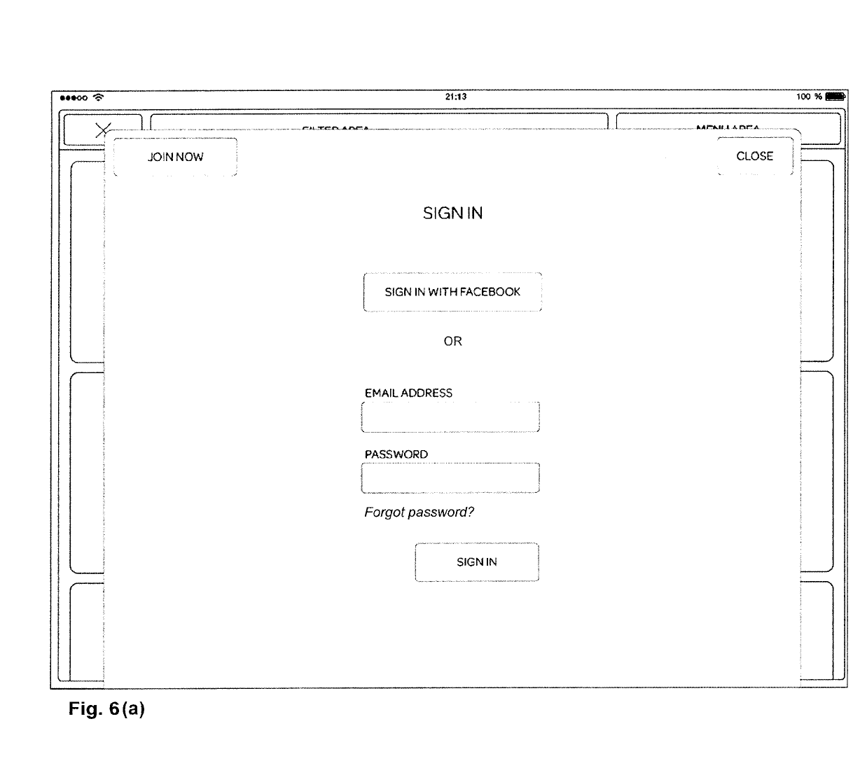

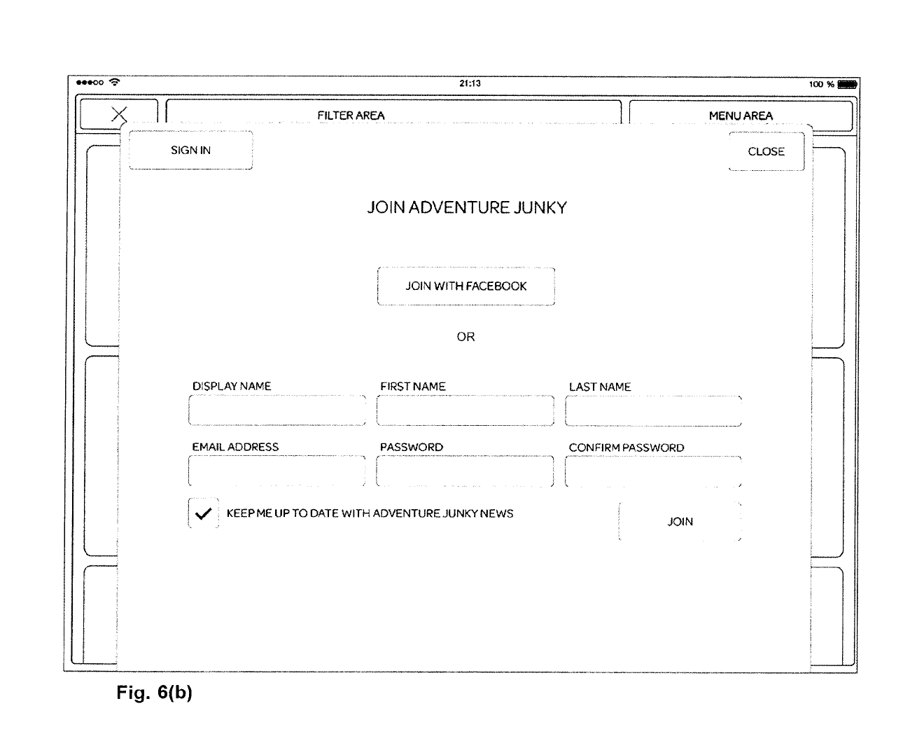

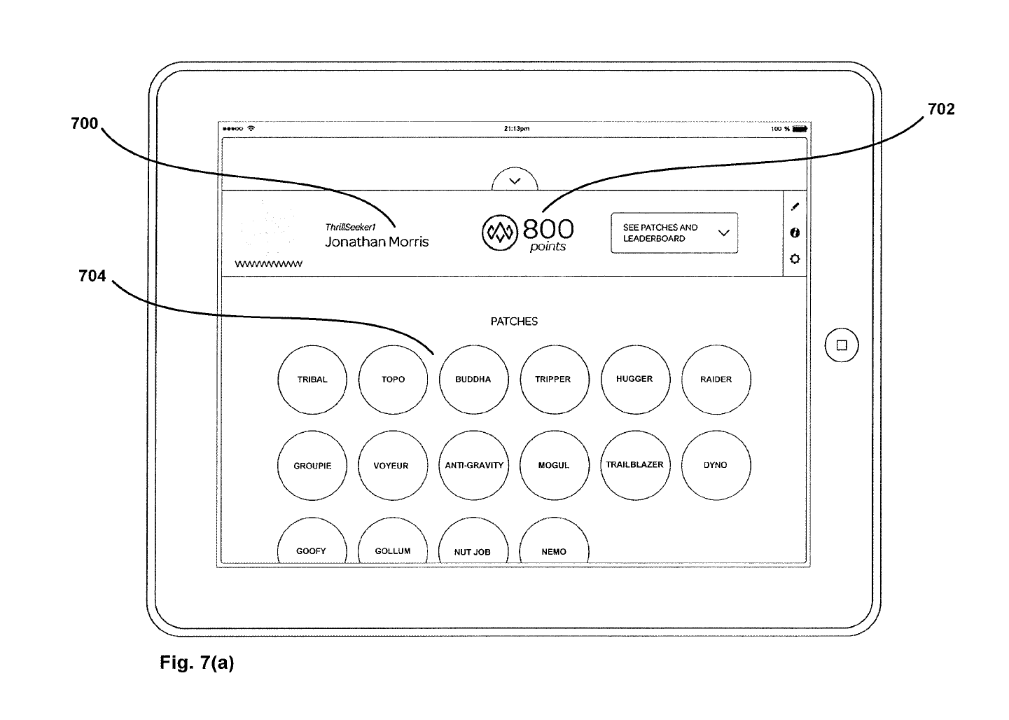

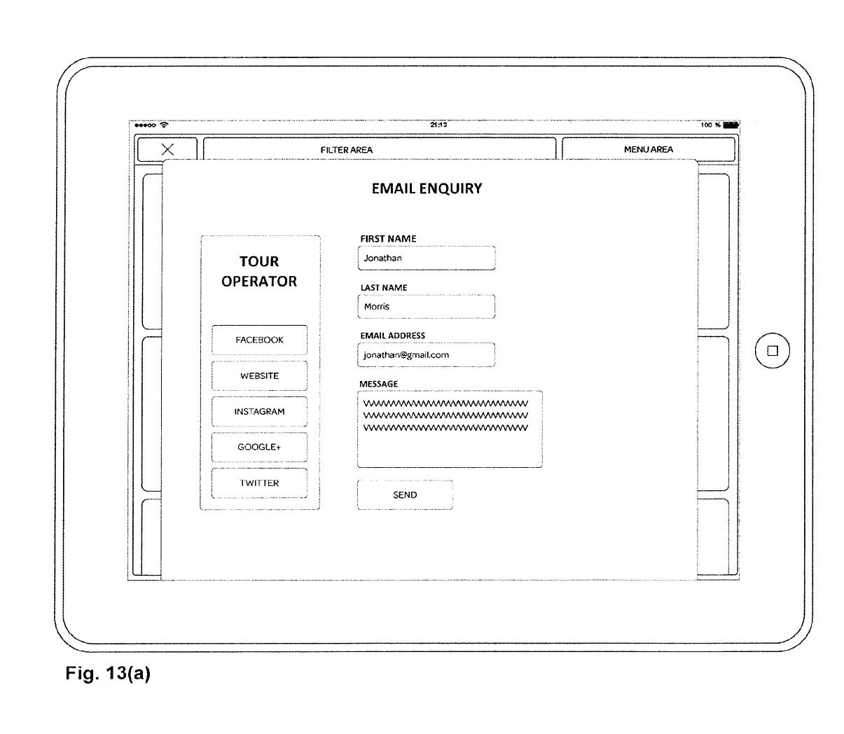

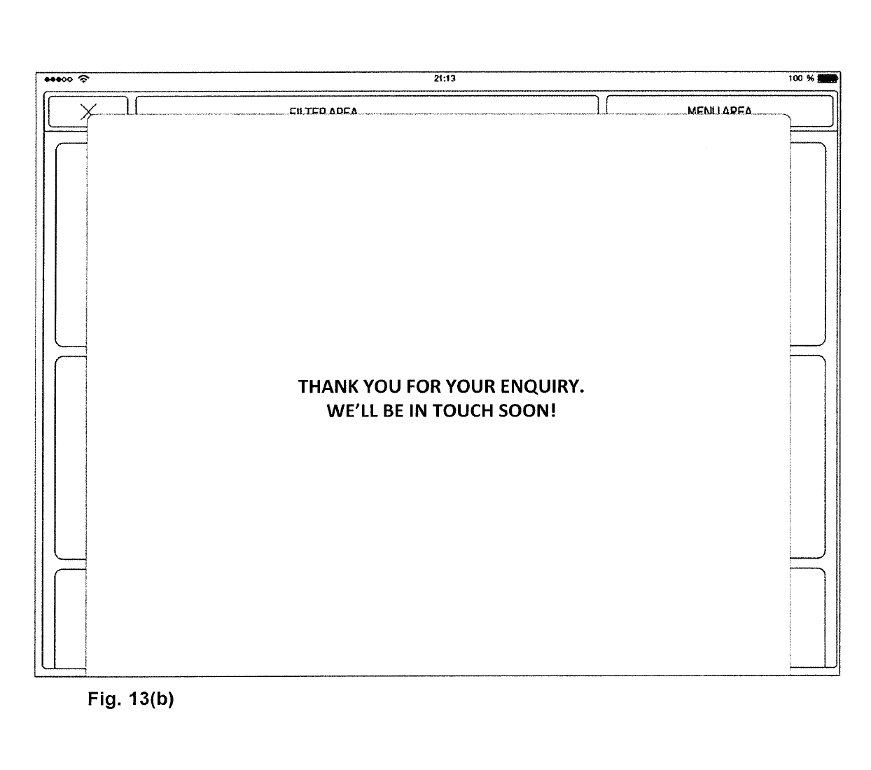

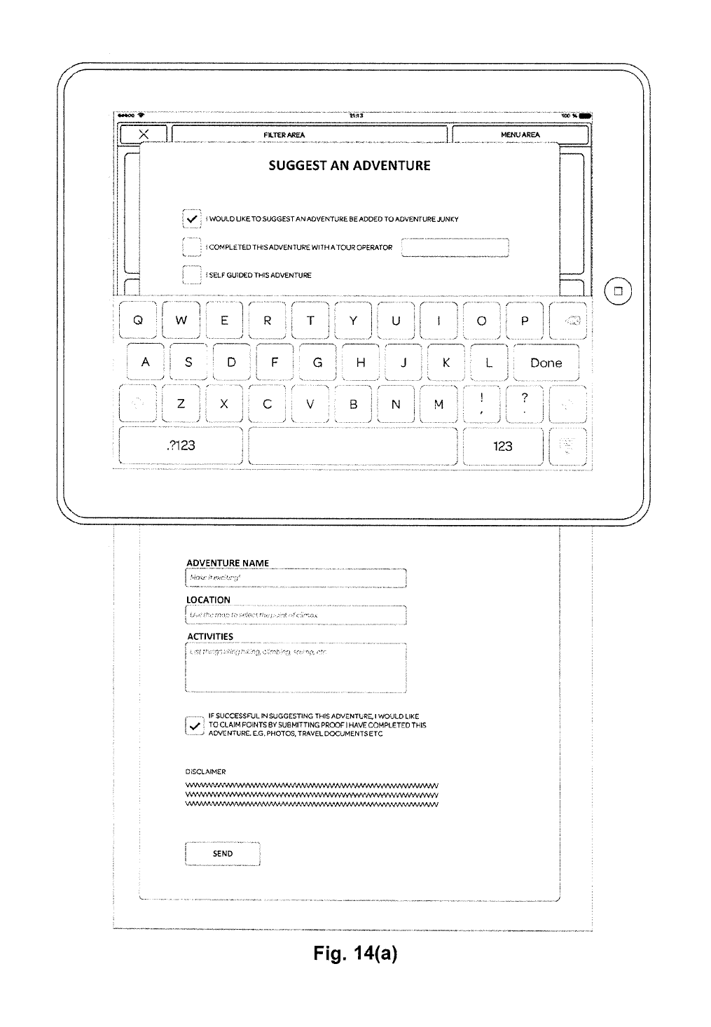

The server also provides the interface module 200 to provide the interfaces described in relation to FIGS. 6(a) to 18. Also the interfaces may offer a platform for sharing of local knowledge such as user experiences and advices on destinations and activities, users to rate and review activities, with the best being showcased to users and prompted in search queries.

The e-commerce booking system 460 showcases searchable guided activities, from all over the world that facilitates direct bookings from the user and points collection.

Client System 122

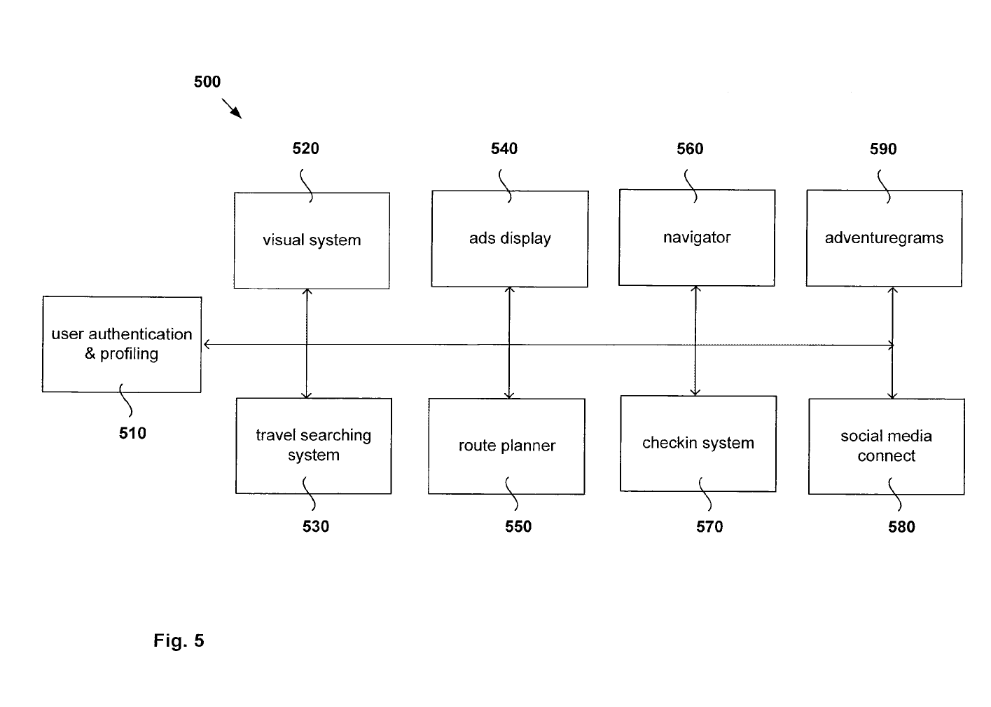

On the client side, being the user's mobile communication device 122, the software is in the form of an app designed to run on smartphones, tablet computers, laptops, desktop computers and other mobile devices 122 and available through application distribution platforms such as the Apple App Store, Google Play, Windows Phone Store, and BlackBerry App World. The software on the client as shown in FIG. 5 communicates to the server through the communication network 150 and the software is comprised of the following main systems:

A user configurable visual system 520 with user interfaces that displays
User targeted images from the world's best travel and adventures.
Cinematic sports and adventure film content filtered for user relevance.
Activity information indicating the respective rewards, being points score and merit patches, GPS location.
Profiles and pictures of leading adventurers and their recommendations.
Information of guided adventure activities, such as the cost, duration and dates of availability.

User authentication and profiling system 510 with user interface shown in FIG. 6(a) for users to sign in to be able to access information stored in their user account by means of user's Facebook account or with user's pre-registered email address and password. In the case of new user, as shown in FIG. 6(b) information such as the display name, personal credentials and password information are required from the user. Once entered a record representing the user's account is stored in the datastore 420. The profiling system also facilitates updates on user profile information.

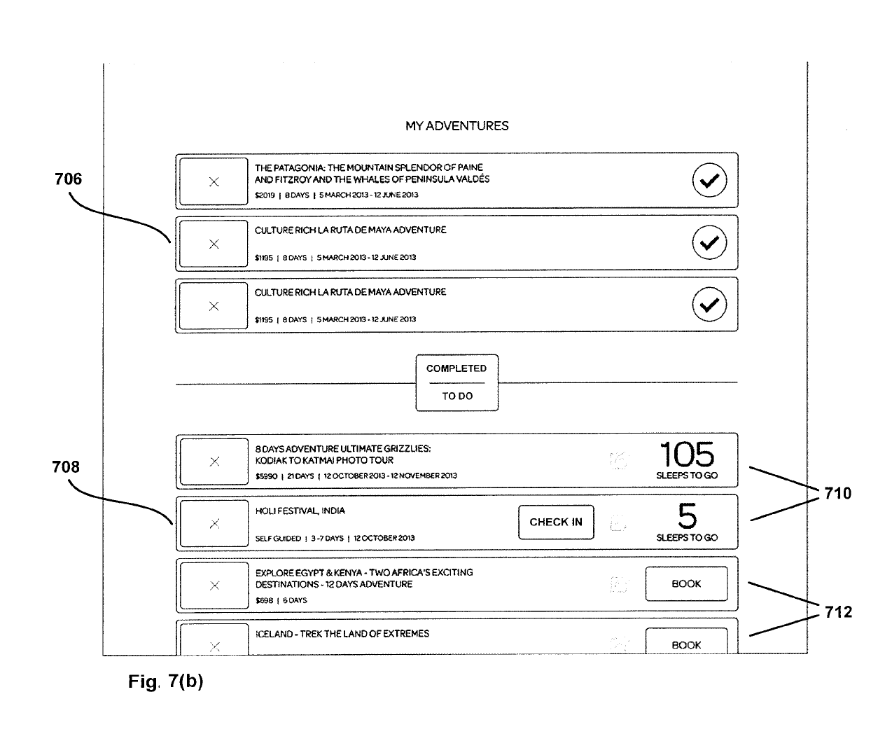

The user can view the information in their user account or determined by profiling on their user account, such as bucket list, comfort zone, booked and completed activities, rewards previously awarded including points scored, merit patches and rankings. An example interface is shown in FIG. 7(a) that shows the user's name 700, the reward associated with that user's account. In this case the rewards are the point total 702 and the patched 704.

The user can also view the details of activities completed 706 and the activities that are yet to be completed 708. In this case the activities that have been booked in, in that the user has made a commitment to complete, an indication is also made on the amount of time 710 until that activity is due to start. Otherwise, the remaining activities are the remaining activities on the user's bucket list and the user is invited by a “book” element 712 to make a booking to complete the activity.

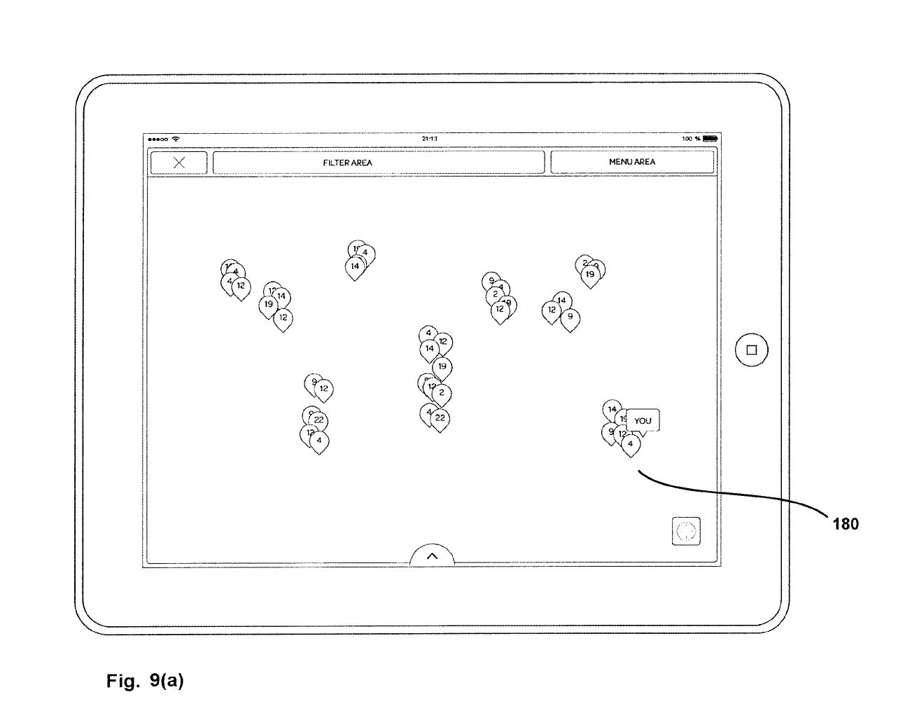

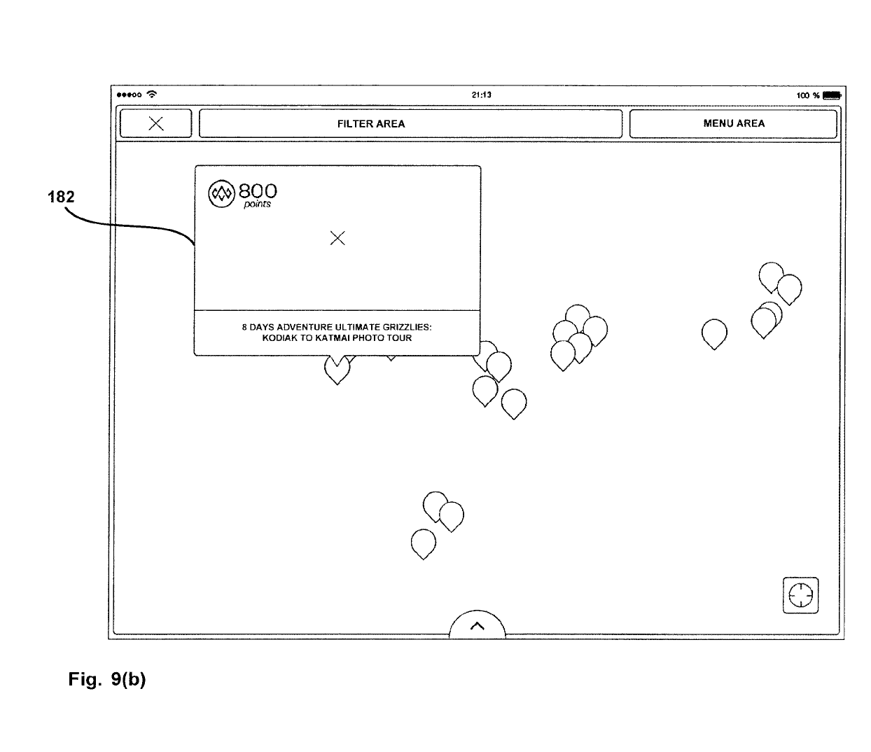

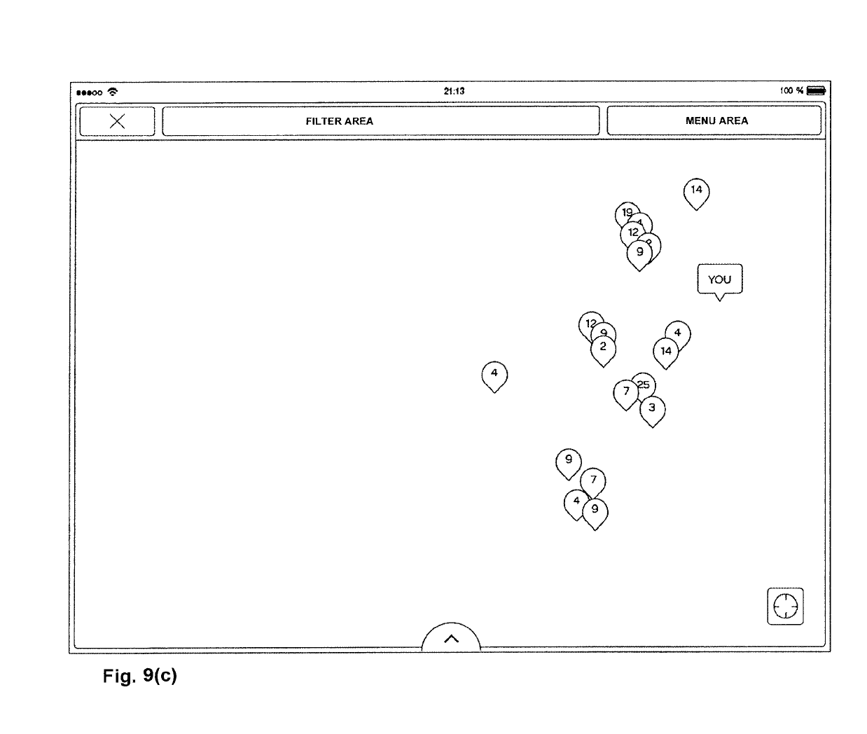

A travel searching system in conjunction with a booking system 530 that allows users to search and book travels directly through the app. User interface allows the user to search for travel adventures as shown in FIG. 9(a) where a map is displayed with markers at the locations where activities can be completed. Each marker (one indicated at 180) includes a number representing the number of points being the reward for completing that activity. As shown in FIG. 9(b) by hovering over the marker details a pop up 182 appears that includes a summary of that activity, including points. FIG. 9(c) shows an interface where the user has filtered the search for results to a smaller geographical area than FIG. 9(a).

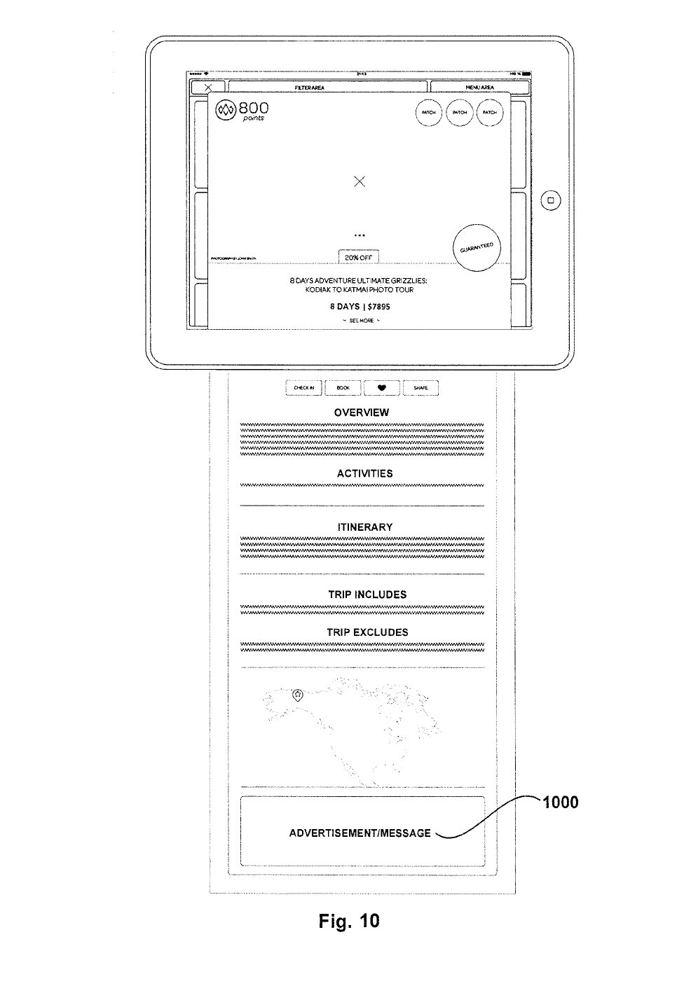

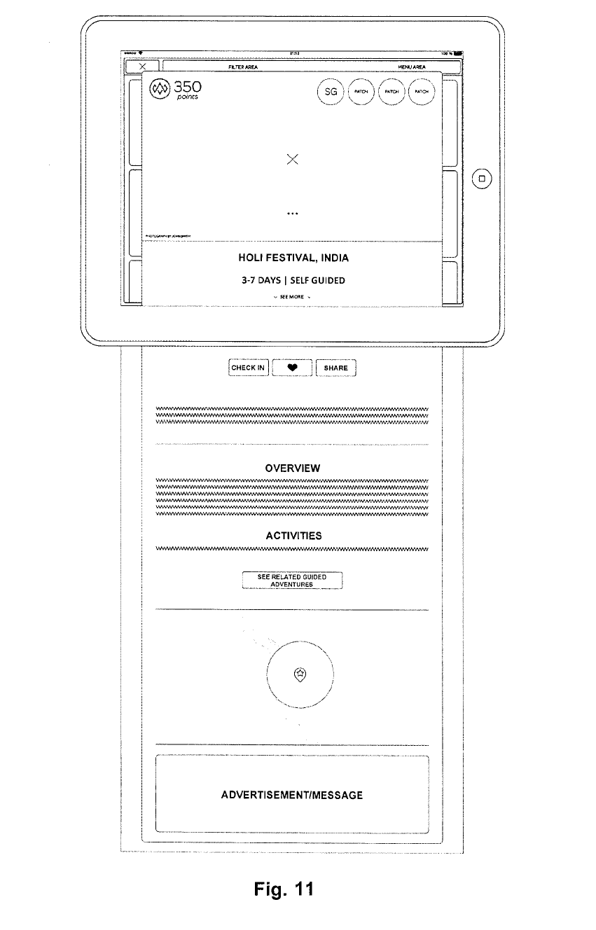

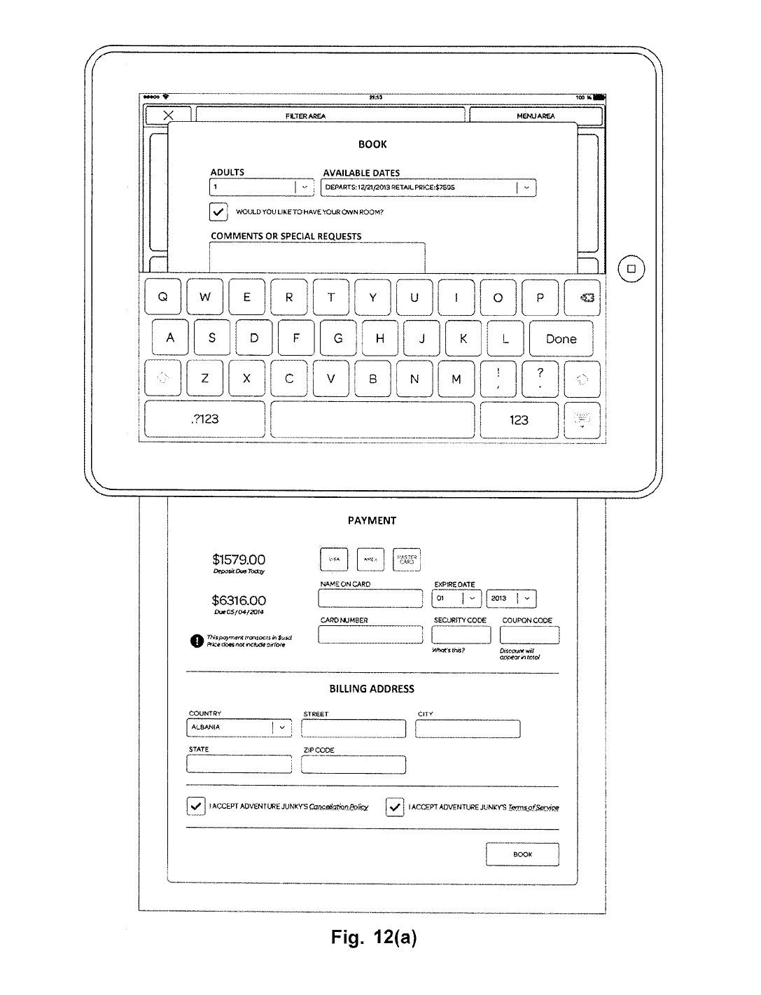

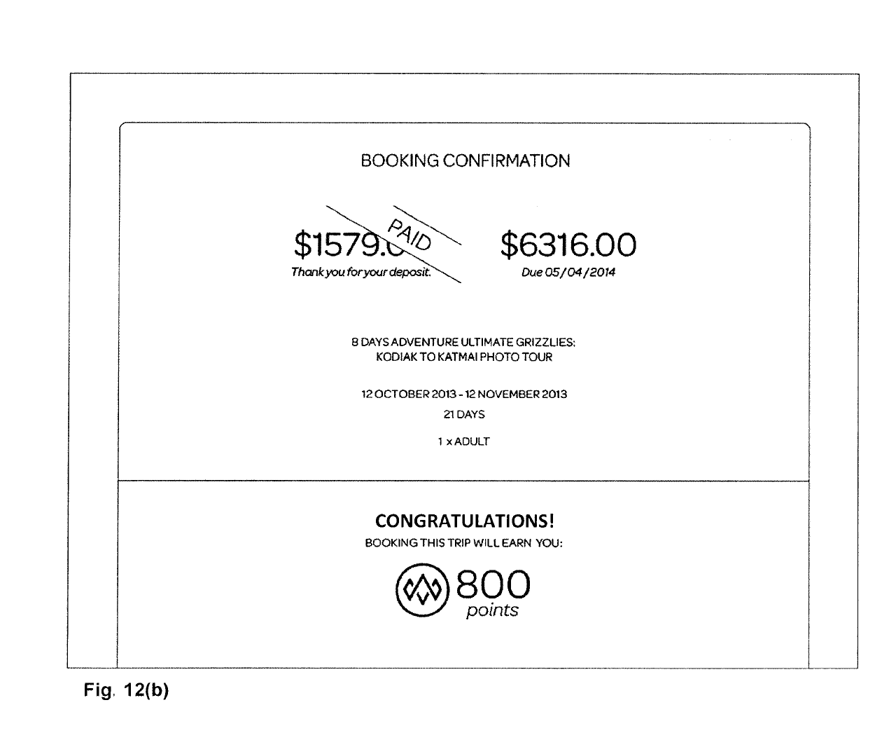

By clicking on the pop-up 182 more details are displayed as shown in FIG. 10. From here this interface the user can go ahead and book using the interface shown in FIG. 12. Alternatively, the activity may be self-guided as shown in FIG. 11 in which case no formal booking or payment is required.

There are other ways for a user to navigate a user interface to explore the content of the user account and activity database 410 than that described here.

As a payment is made through the app, points are automatically awarded and placed in the user's app wallet.

Advertisement display and activation platform 540 assists in providing advertisements to the user interfaces such as shown at 1000 in FIG. 10. The advertisements are typically limited offers and discounted pricing on activities or 30, 60 second of brand video advertising content, recommended gear, apparel or equipment and alliance partners.

Route planner is a route planner tool 550 that receives travel information from the server to coordinate travel with various transport modalities such as plane, train, bus, ferry, etc.

Navigator mapping and compass tool 560 to assist users reaching control points.

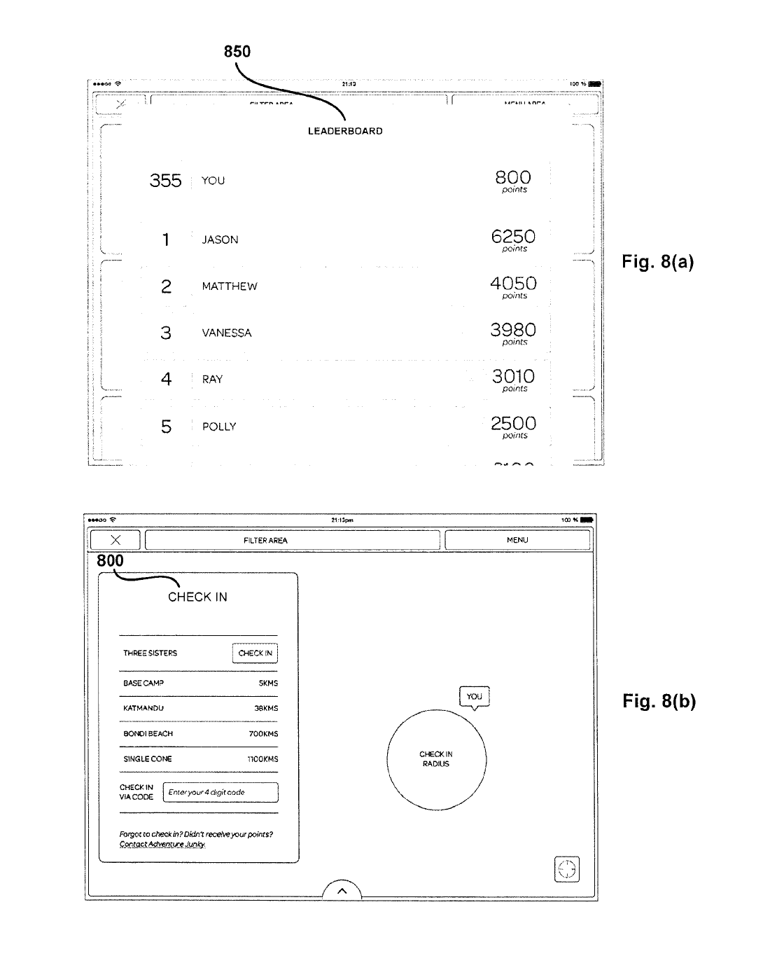

Check-in system 570 that allows a user to check-in at a control point at the completion of an activity using NFC, in order to verify they have undertaken the adventure and collect their reward in their user account. GPS and/or Quick Response (QR) code may be additionally used. Referring again to FIG. 2 the user's device 122 received information identifying an activity, in this case using near field communication. Referring to FIG. 8 the user selects the element “check in” 800. The mobile device 122 of the user is near field communication enabled. An unpowered NFC chip 150 (also referred to as a tag) is typically located in a way that every access to the chip 150 is evidence that the activity has been completed. The chip has stored on it at least a unique identifier of the activity that it is associated with. For example, if it is skiing to the end of a particular ski run, a pole may be located that has embedded the chip. The chip stores an identifier of the associated activity, being the ski run. The identifier in this example is the unique key in the activities 410 database. The user places their NFC enabled device 122 into close proximity.

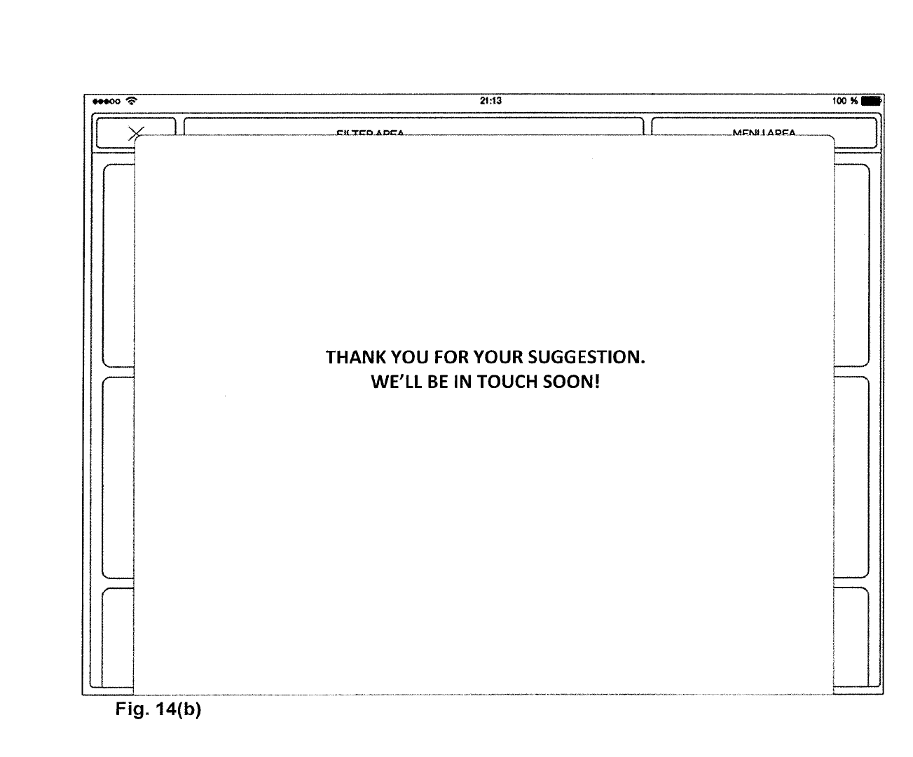

Social media connect systems and forums 580 with user interfaces shown in FIG. 14 allow users to seek advice from other users and expert in particular subjects, destinations or activity, rate and or review adventures and invite friends to download the app and share information.

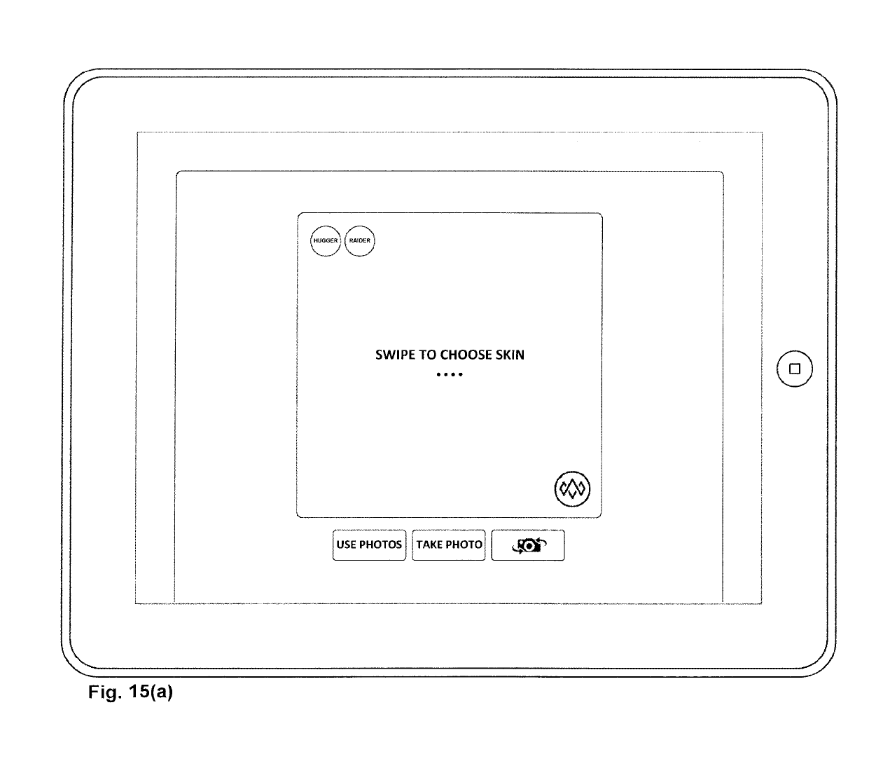

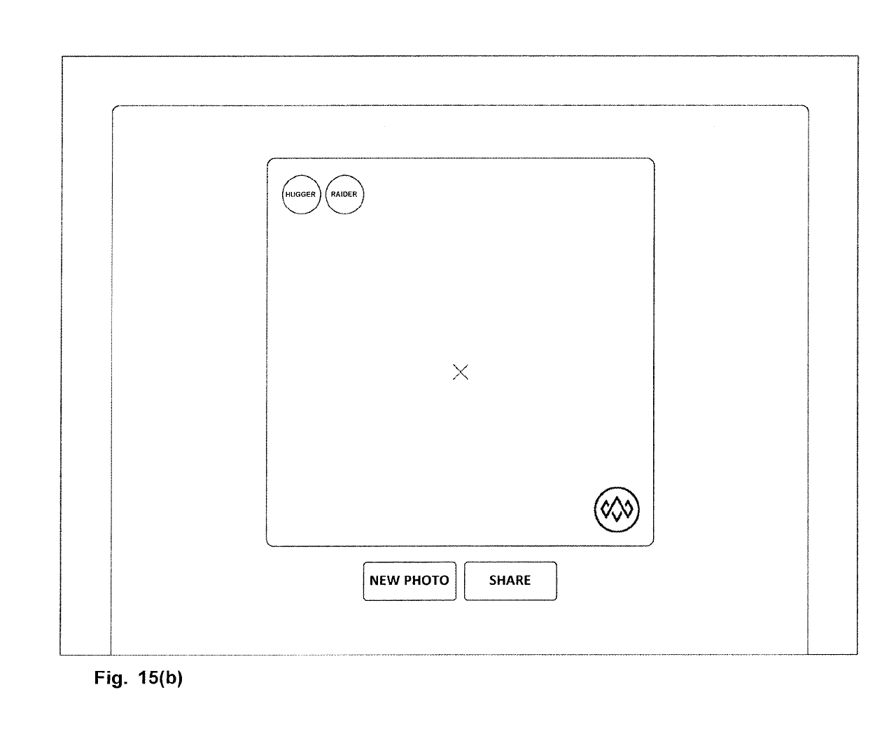

Adventuregrams 590 shown in FIG. 15 allows users to post an image of themselves or their adventure, to the social networks of choice, featuring a number of image overlay options including the location, geographical coordinates, points score, digital patch, or text captions.

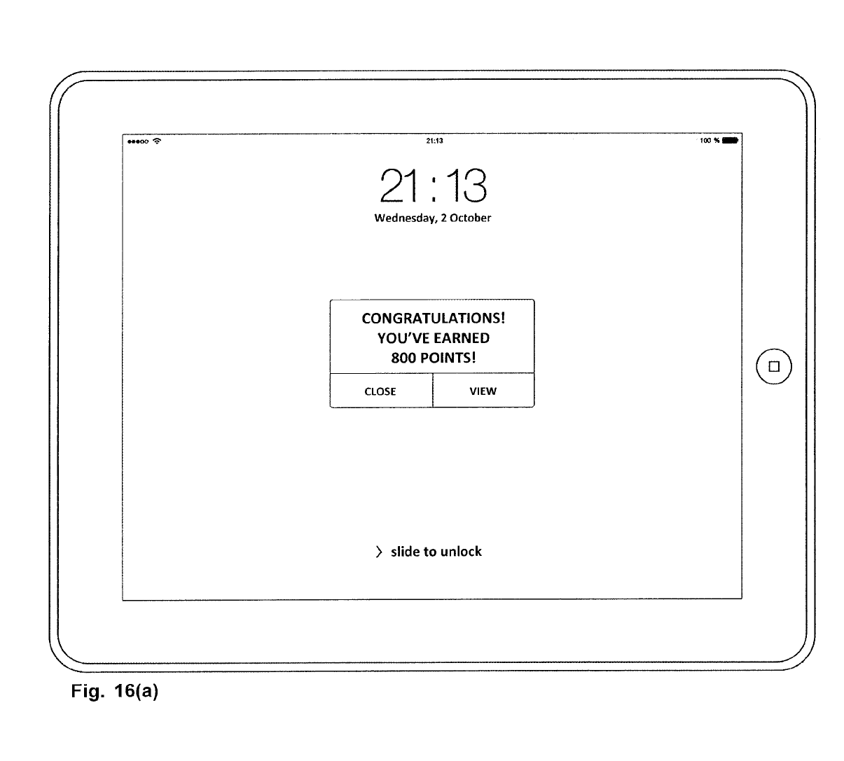

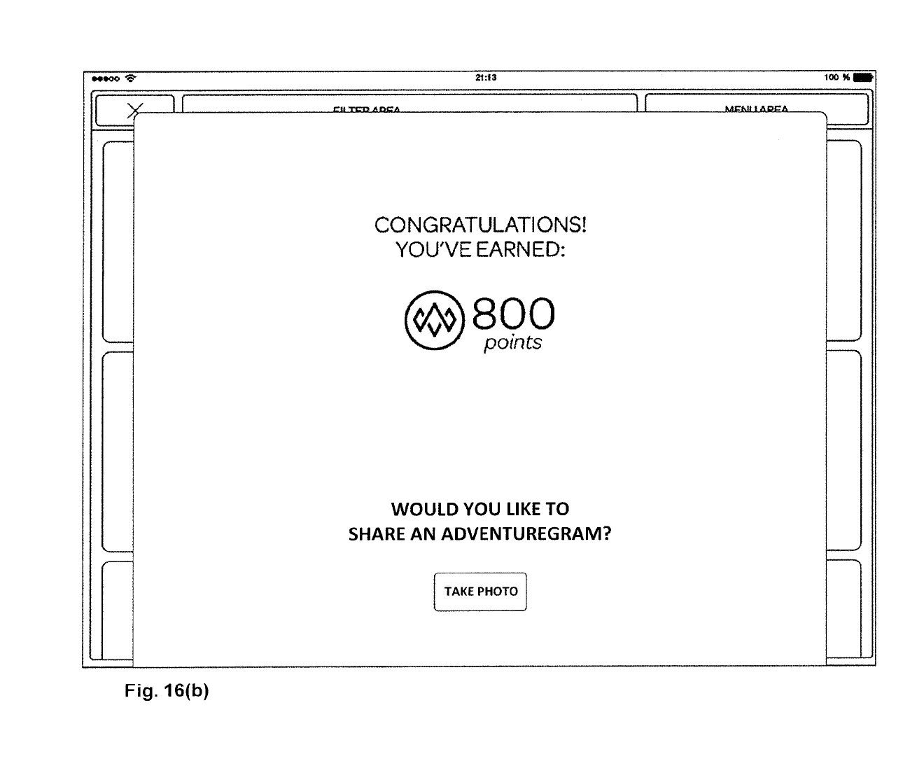

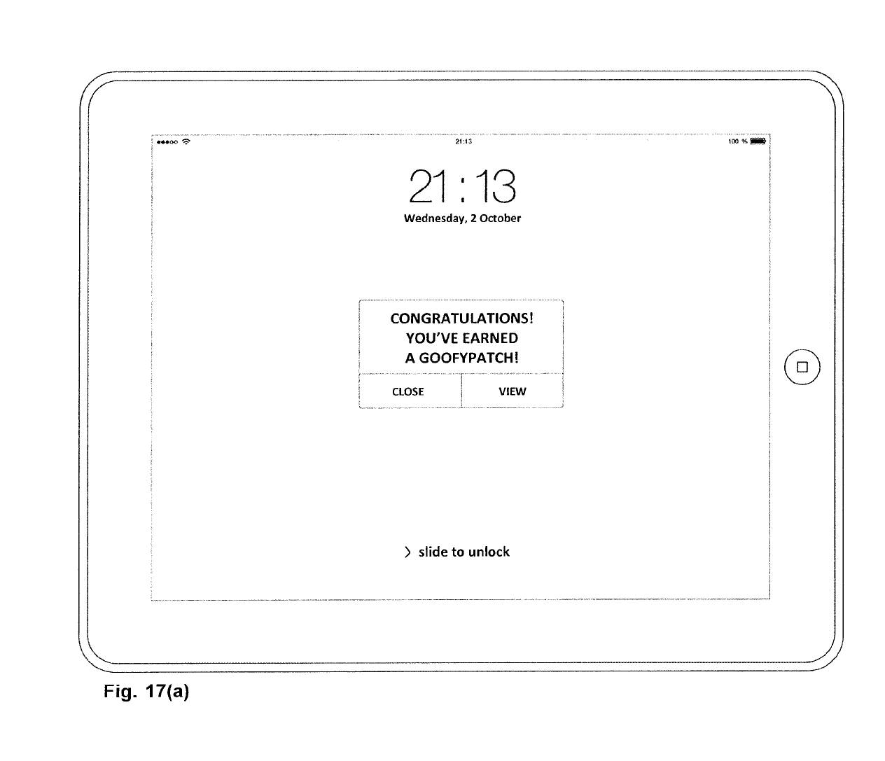

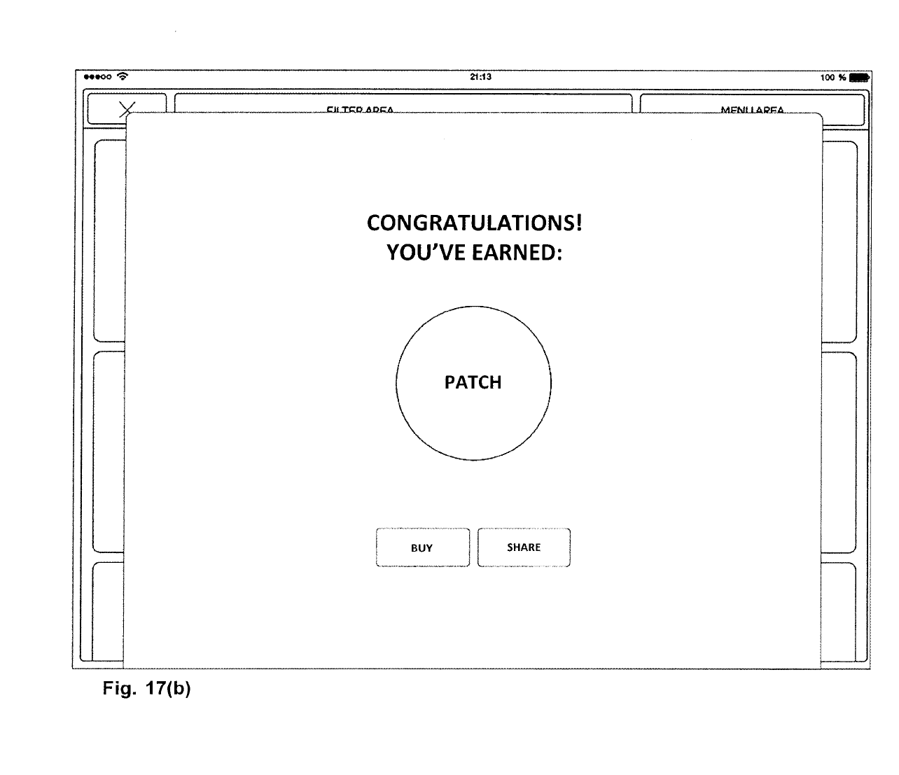

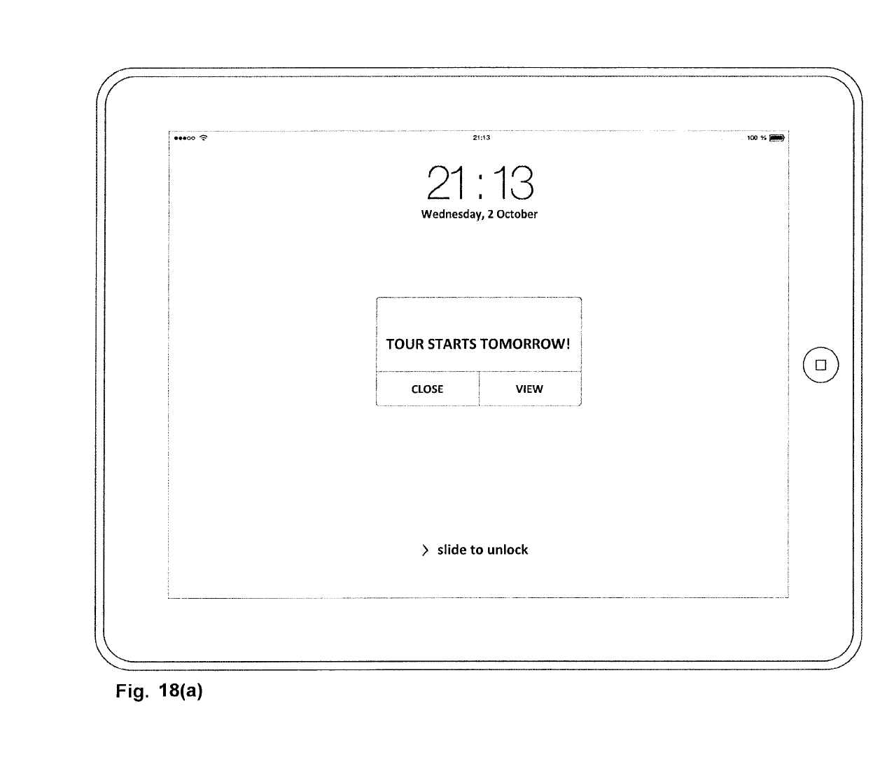

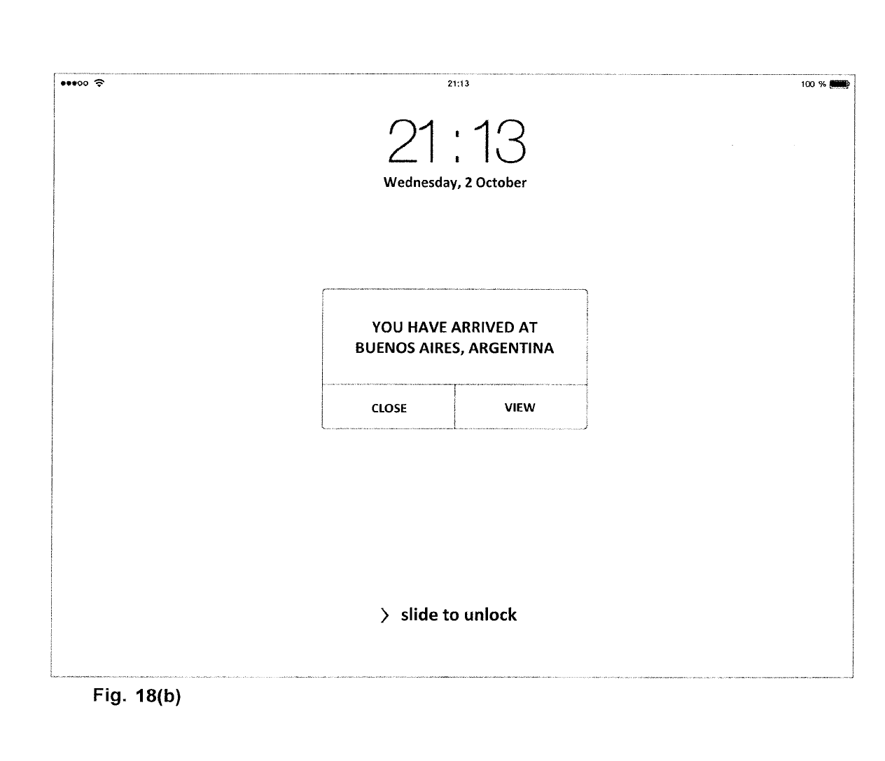

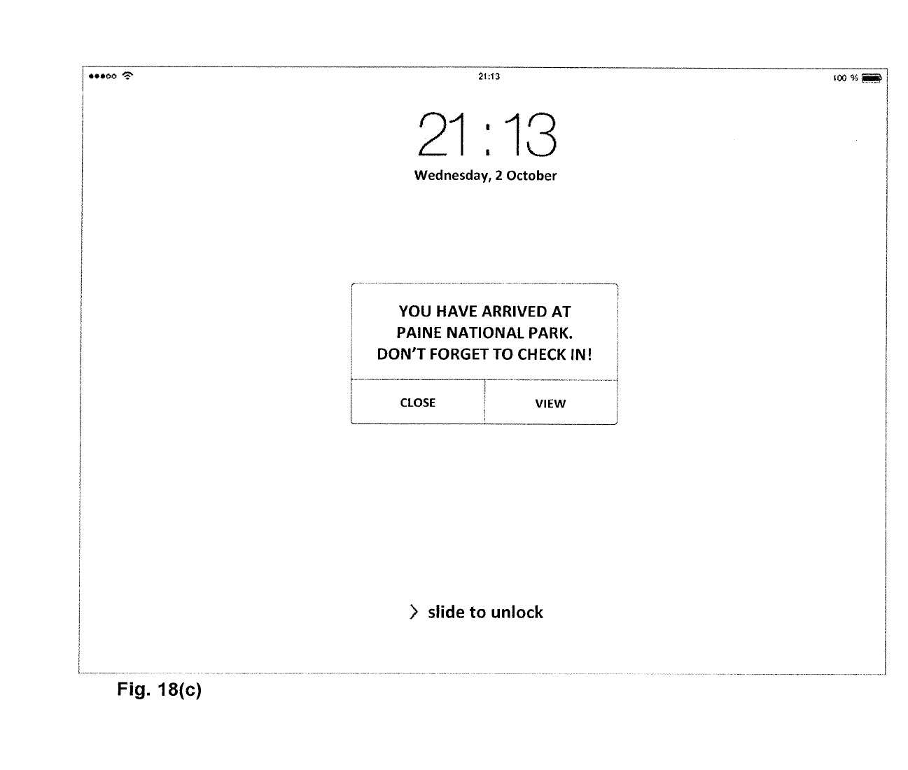

Notifications system that receives information from the server and notifies the user in the event of earning points or patches as illustrated in FIG. 16 and FIG. 17, reminders on starting tours and completion of an adventure in FIG. 18.

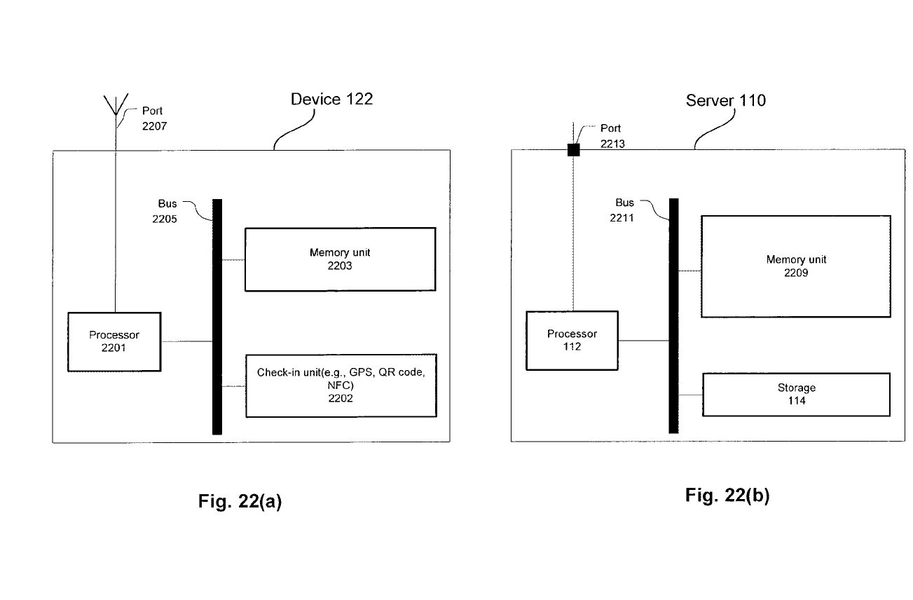

FIG. 22(a) shows an example of the device 122 used by the user 120, and FIG. 22(b) shows an example of the server 110.

The device 122 shown in FIG. 22(a) will now be described with reference to FIG. 2(b). As shown in FIG. 22(a), the device 122 includes a processor 2201, a communication unit 2202, a memory unit 2203, a bus 2205 and a port 2207. The memory unit 2203 stores instructions for the processor 2201 to implement functions shown in FIG. 2(b). The instructions also implement the graphical user interface presented in FIGS. 6(a) to 18. In this example, the instructions are categorised as function modules shown in FIG. 5. The processor 2201 obtains the instructions from the memory unit 2203 via the bus 2205. The port 2207 serves as a physical interface for the device 122 to communicate with other entities in the computer system 100. For example, the port 2207 is a wireless interface for the user 120 carrying the device 122 to verify completion of a travel adventure activity with a NFC-supported hotspot. The user 120 also registers with the server 110, via the port 2207 or sends, via the port 2207, a request to the server 110 to store an indication of completion of a travel adventure activity. The check-in unit 2202 is used to check in when the user 120 completes a travel adventure activity, which is a NFC-enabled unit and may also be a GPS or QR code-enabled unit.

In this example, the processor 2201 of the device 122 receives, from the user 120, information such as the display name, personal credentials and password to cause a user account to be created at the server 110. This way the user 120 is registered 212 with the server 110 in the computer system 100. Alternatively, if the user 120 has already registered with the server 110, the processor 2201 simply sends user information such as the user's email address and password to the server 110 to sign in the system 100. In one example, the registration process 212 in FIG. 2(b) may include ID verification of the user 120 by the server 110 via an integrated or separate ID verification system (not shown in FIG. 2(b))

Once the user 120 completes a travel adventure activity, the user 120 checks in at a control point by using the check-in unit 2202 of the device 122 that includes at least NFC and may additionally have GPS or QR Code, in order to verify the user 120 has undertaken the adventure activity and collect their reward in the user account. As a result, the processor 2201 receives 214 information identifying the activity. A GPS check-in utilises the in-built GPS within the device 122 to confirm the arrival within the vicinity of the predefined location. It will be appreciated that the vicinity is determined based on the radius or zone typically equidistant around the GPS coordinate of the point of interest as recorded in the record for the activity in the database 310 shown in FIG. 3 . NFC check-in requires the user 120 to swipe the device 122 across a NFC supported hotspot such that the identifier of the activity is read by the device 122 from the NFC supported hotspot. Multiple NFC hotspots are used in the presence of multiple adventures. In addition, the user can check-in via QR code by scanning the QR Code with the device 122 that is again made available to the user 120 on completion of the activity, such as by printout given to the user 120 by a control point operator. Multiple QR codes are required in the presence of multiple adventures.

The processor 2201 then sends 216 a request over the communications network 150 via the port 2207 to the server 110 to store in the datastore 114 associated with the user's account an indication of completion of the activity, wherein the request includes the information identifying the activity.

Upon receipt of the request at the server 110, the server 110 updates the user's account with a reward associated with the completion of the activity and sends a confirmation message over the communication network 150 to the device 122, which will be described in detail below with reference to the server 110.

The confirmation message is received 218 at the processor 2201 of the device 122, indicating that the user's account in the datastore has been updated with the reward associated with completion of the activity.

The server 110 shown in FIG. 22(b) will now be described with reference to FIG. 2(c). As shown in FIG. 22(b), the server 110 includes the processor 112, the datastore 114, a memory unit 2209, a bus 2211 and a port 2213. The memory unit 2209 stores instructions for the processor 112 to implement functions shown in FIGS. 2(c). All information needed by the server 110 on the user 120, administrator 130, activities, and advertisements is stored in the datastore 114. The instructions may also implement user interface module 200 in FIG. 4. In this example, the instructions are categorised as function modules shown in FIG. 4. The processor 112 obtains the instructions from the memory unit 2209 via the bus 2211. The port 2213 serves as a physical interface for the device server 110 to communicate with other entities in the computer system 100. For example, the port 2213 is a wireless or wireline network interface card (NIC) to connect the server 110 to the communication network 150, via which messages are sent to and/or received from the device 122 in various stages of operation of the computer system 100.

As described above with reference to the device 122 carried by the user 120, the processor 112 of the server 110 receives 222 the request over the communications network 150 from the device 122 to store in the datastore 114 the completion of an activity.

The processor 112 validates 224 the request based on the criteria associated with the activity. As described above, the server 110 in FIG. 1 verifies the completion of a travel adventure activity 350 by the user 120 using the information included in the request and the user's account information. In this example, the processor 112 of the server 110 checks if the user 120 has the authorisation to participate in the activity by for example checking if the user 120 has booked the activity based on the information stored in datastore 310. If the user 120 has not booked the activity yet, the request is rejected by the server 110. In another example, if the request is rejected as the user 120 has not booked the activity, the processor 112 prompts the user 120 to book the activity by presenting a web page or link through which the user 120 can book the activity, as shown in the e-commerce booking engine 460 in FIG. 4.

Once the request is validated, the processor 112 updates 226 the user's account in the datastore 114 by adding an “Activity Points” score associated with the completion of the activity to the current “Activity Points” in the user's account. The “Activity Points” score is determined based on an activity point algorithm that takes “Challenge” factors into account.

In this example, the “Activity Points” score is stored in the datastore 114 and retrieved by the processor 112 from the datastore 114 to update the user's account according to the information identifying the activity. In another example, the “Activity Points” score is determined in real time when the server 110 receives the request from the device 122.

In this example, the user earns the “Activity Points” score by undertaking pre-selected travel adventure activities. Following GPS, NFC or QR code check-in, an “Activity Points” score is added to the user's account confirming the successful completion of the travel adventure activity, typically by simply adding the “Activity Points”. In the context of the present disclosure, “Activity Points” is the means to progress through the travel adventure. Users that reach the top of the Adventure Junky Leader Board are awarded the Orange “Patch” of merit, the equivalent of the yellow jersey in the Tour de France or being top of the World Rankings. The users also receive Patches for reaching pre-defined “Activity Points” milestones and other achievements. The “Activity Points” are the currency of the travel adventure. Particularly, “Activity Points” can be earned, bought, traded and generate rewards for app users, not only in the virtual world, but also in the real-world. These include transferring “Activity Points” to and from third-party frequent flyer or credit card rewards programs, receiving discount on future adventure bookings or receiving discounts and special offers from third-party sponsors, advertisers and alliance partners.

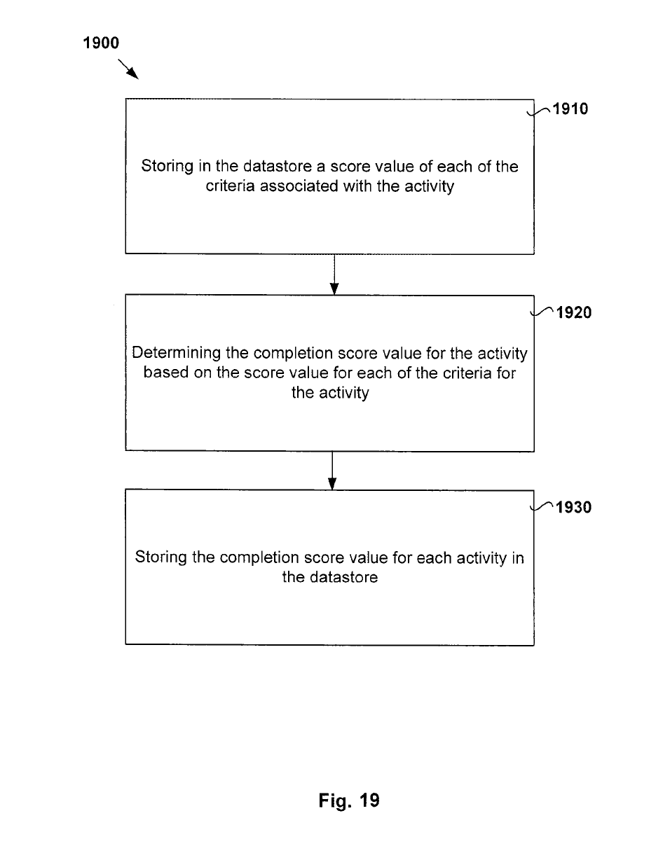

The activity point algorithm 1900 performed by the processor 112 of the server 110 to allocate a completion score value for a travel adventure activity is described below with reference to FIG. 19.

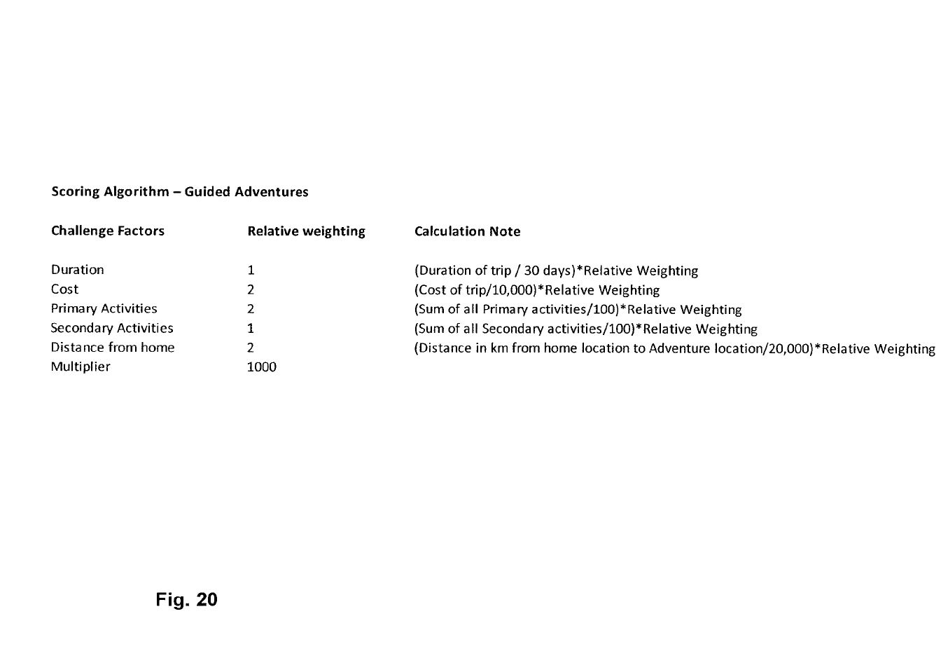

The server 110 stores 1910 a score value for each of the criteria associated with the activity, as shown in FIG. 20. The score value may be received from the administrator 130 via the administrator interface module 220 in FIG. 2(a). In FIG. 20, scores for a predetermined list of criteria, labelled “Challenge” factors, such as distance from home location, primary and secondary activities, are stored in the datastore 114 for the activity. In this example, the criteria stored in the datastore 114 are applicable to each of the one or more activities in the travel adventure. The criteria may further include difficulty, cost, fitness requirement and duration in relation to the activities.

In the case of guided adventures, additional scores for duration and cost for the activity are also taken into account.

In this example, each travel adventure is comprised of at least a primary activity and a secondary activity. These sub-activities within an activity have been rated on a scale from 1 to 00 from soft to extreme, as shown in Table 1 below. The “Activity Points” score for completion of the activity is then determined 1920 based on the score value for each of the criteria. As an example, the “Activity Points” score for the travel adventure activity may be determined based on “Challenge” factors, the relative weighting and numerical relationship between the factors and the relative weighting, as shown in FIG. 20. The “Activity Points” score for the activity is stored 1930 in the datastore 114 for future retrieval.

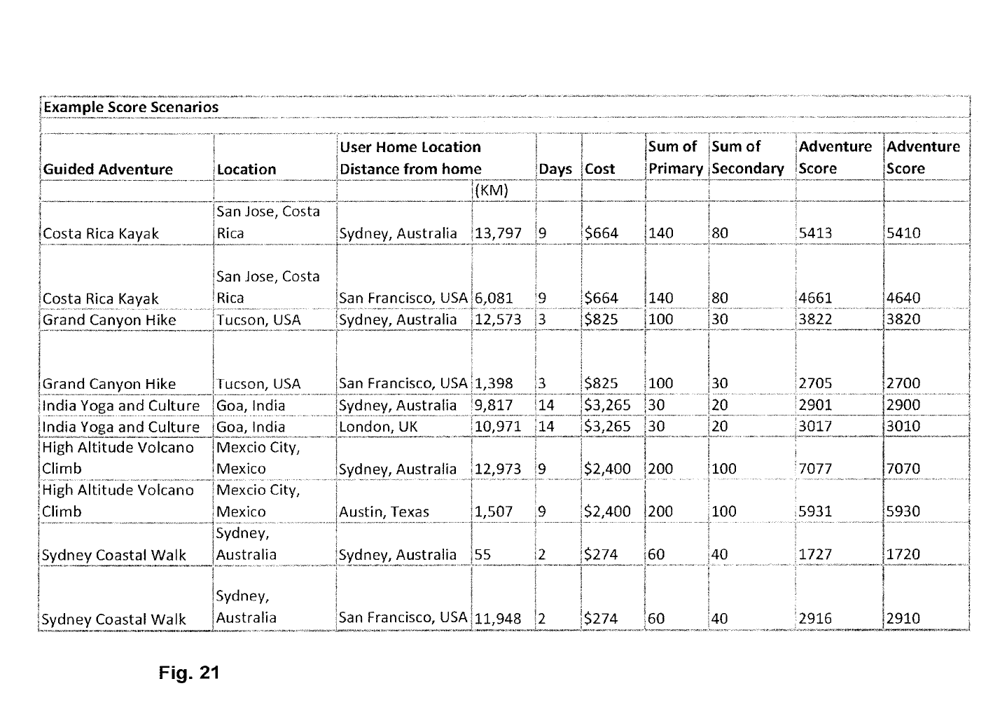

Once the completion score of each of sub-activities of the travel adventure is determined, a raw adventure score for the travel adventure is determined by summing up the individual completion score of each of the sub-activities, the result of which is rounded off to determine the adventure score allocated to the particular travel adventure. As an example, FIG. 21 tabulates examples of travel adventures and their respective adventure scores that correspond to the final completion score.

TABLE 1
Classification of activities on increasing difficulty and score

| Adventure Activity | Rating |
|---|---|
| soft | |
| Beach-combing | 10 |
| Cable cars | 10 |
| Cruises | 10 |
| Cultural | 10 |
| Culinary | 10 |
| Retreats | 10 |
| Spas | 10 |
| Train journeys | 10 |
| Archaeological | 20 |
| Festivals | 20 |
| Astronomy | 20 |
| Wildlife watching | 20 |
| Yoga | 20 |
| medium | |
| Bridge climbing | 30 |
| Road-tripping | 30 |
| Scenic flights | 30 |
| Camping | 40 |
| Fishing | 40 |
| Quad biking | 40 |
| Safari | 40 |
| Slacklining | 40 |
| Zipline | 40 |
| Ballooning | 50 |
| Canoeing | 50 |
| Cycling | 50 |
| Four wheel driving | 50 |
| Horse riding | 50 |
| Stand-up paddle boarding | 50 |
| Sailing | 50 |
| hard | |
| Abseiling | 60 |
| Hiking | 60 |
| Snowshoeing | 60 |
| Surfing | 60 |
| Wakeboarding | 60 |
| Water skiing | 60 |
| Aerobatics | 70 |
| Dogsledding | 70 |
| Downhill Skiing | 70 |
| Tandem Gliding | 70 |
| Tandem Hang-gliding | 70 |
| Kiteboarding | 70 |
| Mountain biking | 70 |
| Motor Biking | 70 |
| SCUBA Diving | 70 |
| Snowboarding | 70 |
| Snowmobiling | 70 |
| Spelunking | 70 |
| Adventure Racing | 80 |
| Bungee jumping | 80 |
| Canyoning | 80 |
| Parkour | 80 |
| Sea kayaking | 80 |
| extreme | |
| Heliski/boarding | 90 |
| Rock climbing | 90 |
| Whitewater rafting | 90 |
| Base Jumping | 100 |
| Cave Diving | 100 |
| Highlining | 100 |
| Ice climbing | 100 |
| Mountaineering | 100 |
| Parachuting | 100 |
| Shark diving | 100 |
| Skydiving | 100 |
| Space | 100 |
| Speed flying | 100 |
| Whitewater Kayaking | 100 |
| Wingsuiting | 100 |

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method performed by a mobile communication device for facilitating the completion of activities by a user, where the mobile communication device is in communication with a server that is in turn in communication with a datastore, the datastore stores information identifying a plurality of activities, a reward associated with completion of each of the activities, and an account associated with the user, the method comprising:
(a) receiving information identifying an activity using near field communication;
(b) sending a request over a communications network to the server to store in the datastore associated with the user's account an indication of completion of the activity, wherein the request includes information identifying the activity; and
(c) receiving over the communications network from the server confirmation that the user's account in the datastore has been updated with a reward associated with completion of the activity.

2. The computer-implemented method of claim 1, wherein the request additionally includes information received by the mobile communication device using global positioning system or a quick response code.

3. A non-transitory computer-readable medium including computer-executable instructions stored thereon that when executed by a processor cause the processor to perform the method according to claim 1.

4. A mobile communication device for facilitating the completion of activities by a user, the mobile communication device comprising:
a communications port for communication with a server that is in turn in communication with a datastore, the datastore stores information identifying a plurality of activities, a reward associated with completion of each of the activities, and an account associated with the user, and for receiving information identifying an activity using near field communication; and
a processing device
to receiving the information identifying the activity using near field communication;
to send a request over a communications network to the server to store in the datastore associated with the user's account an indication of completion of the activity, wherein the request includes the information identifying the activity; and
to receiving over the communications network from the server confirmation that the user's account in the datastore has been updated with a reward associated with completion of the activity.

5. A computer-implemented method performed by a server for determining completion score values of activities to be completed by a user, wherein information on at least one activity and at least one criteria are stored on a datastore, the method comprising:
(a) storing in the datastore a score value for each of the criteria associated with the activity;
(b) determining the completion score value for the activity based on the score value for each of the criteria associated with the activity; and
(c) storing the completion score value for each activity in the datastore.

6. The computer-implemented method of claim 5, wherein the criteria stored in the datastore are criteria applicable to each of the one or more activity.

7. The computer-implemented method of claim 5, wherein the criteria are any one or more of:
difficulty,
cost,
fitness requirement,
duration, and
distance from home location.

8. A non-transitory computer-readable medium, including computer-executable instructions stored thereon that when executed by a processor cause the processor to perform the method of determining completion scores of activities according to claim 5.

9. A computer system for determining completion score values of activities to be completed by a user, comprising:
a datastore to store information on at least one activity and at least one criteria, and to store a score value of each of the criteria associated with the activity; and
a processing device to determine the completion score value for the activity based on the score value for each for the criteria associated with the activity, and to cause the completion score value for the activity to be stored in the datastore.
